(19) United States
(12) Patent Application Publication
(10) Pub. No.: US 2015/0373816 A1
(43) Pub. Date: Dec. 24, 2015

(54) LIGHTING CONTROL SYSTEM

(71) Applicant: INESOCOMPANY LTD, Lockhart Road, Wan Chai (CN)

(72) Inventor: Fabien DHERBASSY, Grenoble (FR)

(73) Assignee: INESOCOMPANY LTD., Wan Chai, Hong Kong (CN)

(21) Appl. No.: 14/765,815

(22) PCT Filed: Feb. 7, 2014
(86) PCT No.: PCT/FR2014/050241

§ 371 Date: Aug. 4, 2015

(30) Foreign Application Priority Data
Feb. 7, 2013 (FR) 1351050

(51) Int. Cl. H05B 37/02; G05B 15/02

(52) U.S. Cl. CPC H05B 37/0272; G05B 15/02

(57) ABSTRACT

A method for installing a wireless lamp controller in a lighting control system, the method including reading, by a mobile installation device, configuration parameters from an element, that is readable by machine, of the wireless lamp controller; determining position data indicating a current position of the mobile installation device; and transmitting, by the mobile installation device, the configuration parameters and the position data to a central server.

### FIELD

The present disclosure relates a lighting control system comprising wireless lamp controllers, and in particular to a method and installation device for installing a wireless lamp controller in a lighting control system, and to a lighting control system.

### BACKGROUND

Lighting networks, and in particular street lighting networks, represent a relatively high proportion of overall energy use in large towns and cities. A large reduction in energy consumption can be achieved by replacing traditional incandescent lighting elements in street lamps by low energy LED light elements.

Additionally, it has been proposed to use intelligent lighting control systems to economize energy. Such systems permit street lamps to be turned off or their brightness reduced during non-peak times, for example at certain hours of the night. Such systems generally involve the addition of a lamp controller to each lamp, permitting the lighting of each lamp to be controlled independently.

While there is a clear benefit in such systems, the installation of such systems can be time consuming and costly. Indeed, there are thousands of street lamps in a typical town or city, and known methods for installing lamp controllers are far from efficient, and there is thus a technical problem in providing a method and device for the installation of lamp controllers in such lighting control systems.

### SUMMARY

It is an aim of embodiments of the present description to at least partially address one or more problems in the prior art.

According to one aspect, there is provided a method of installation of a wireless lamp controller in a lighting control system, the method comprising: reading, by a mobile installation device, setup parameters from a machine readable element of said wireless lamp controller; determining position data indicating a current position of the mobile installation device; and transmitting, by the mobile installation device, the setup parameters and the position data to a central server.

According to one embodiment, the setup parameters comprise one or more of: an encrypted key associated with said wireless lamp controller; an identifier associated with said wireless lamp controller; and data indicating functions of said wireless lamp controller.

According to one embodiment, the machine readable element is one of: an image readable by a camera of said mobile installation device; and a wireless transponder readable by a near-field communications interface of said mobile installation device.

According to one embodiment, the method further comprises: receiving by said central server the setup parameters and position data from the mobile installation device; generating an activation code based at least partially on one or more of said setup parameters; based on said position data, selecting one of a plurality of segment modules of said lighting control system; and transmitting said activation code to said wireless lamp controller via said selected segment module.

According to one embodiment, the setup parameters comprise an encrypted key associated with said wireless lamp controller, and wherein said central server is adapted to compare said key with a reference key associated with said wireless lamp controller.

According to one embodiment, the method further comprises: storing by said central server said position data in a memory in association with an identifier of said wireless lamp controller; and transmitting by said central server said position data to said wireless lamp controller.

According to a further aspect, there is provided a mobile installation device comprising: a read device configured to read setup parameters from a machine readable element of a wireless lamp controller to be installed in a lighting control system; a positioning device configured to determine position data indicating a current position of the mobile installation device; and a wireless communications interface configured to transmit the setup parameters and the position data to a central server.

According to one embodiment, the read device is one of: a camera configured to capture an image of said machine readable element; and a near-field communications interface configured to wirelessly communicate with said machine readable element.

According to one aspect, there is provided a lighting control system comprising a central server adapted to: receive, from a mobile installation device, setup parameters associated with a wireless lamp controller to be installed in said system, and position data associated with said mobile installation device; generate an activation code based at least partially on one or more of said setup parameters; select, based on said position data, one of a plurality of segment modules of said lighting control system; and transmit said activation code to said wireless lamp controller via said selected segment module.

According to one embodiment, the setup parameters comprise an encrypted key associated with said wireless lamp controller, and wherein said activation code includes the key.

### BRIEF DESCRIPTION OF THE DRAWINGS

The foregoing and other features and advantages will become apparent from the following detailed description of embodiments, given by way of illustration and not limitation with reference to the accompanying drawings, in which:

FIG. 1 illustrates a street lighting network according to an example embodiment of the present disclosure;

FIG. 2 schematically illustrates a lighting control system according to an embodiment of the present disclosure;

FIG. 3 schematically illustrates a mobile installation device of the system of FIG. 2 in more detail according to an embodiment of the present disclosure;

FIG. 4 schematically illustrates a wireless lamp controller of the system of FIG. 2 in more detail according to an example embodiment of the present disclosure;

FIG. 5 schematically illustrates a central server of the system of FIG. 2 in more detail according to an example embodiment of the present disclosure; and

FIGS. 6A and 6B are flow diagrams showing operations in a method of installation of a wireless lamp controller according to an example embodiment of the present disclosure.

### DETAILED DESCRIPTION

While throughout the following description, embodiments are described with reference to a street lighting control system, it will be apparent to those skilled in the art that the techniques described herein could be equally applied to other types of lighting control systems, such as control systems for controlling the lighting on relatively large structures, such as large monuments, buildings or the like.

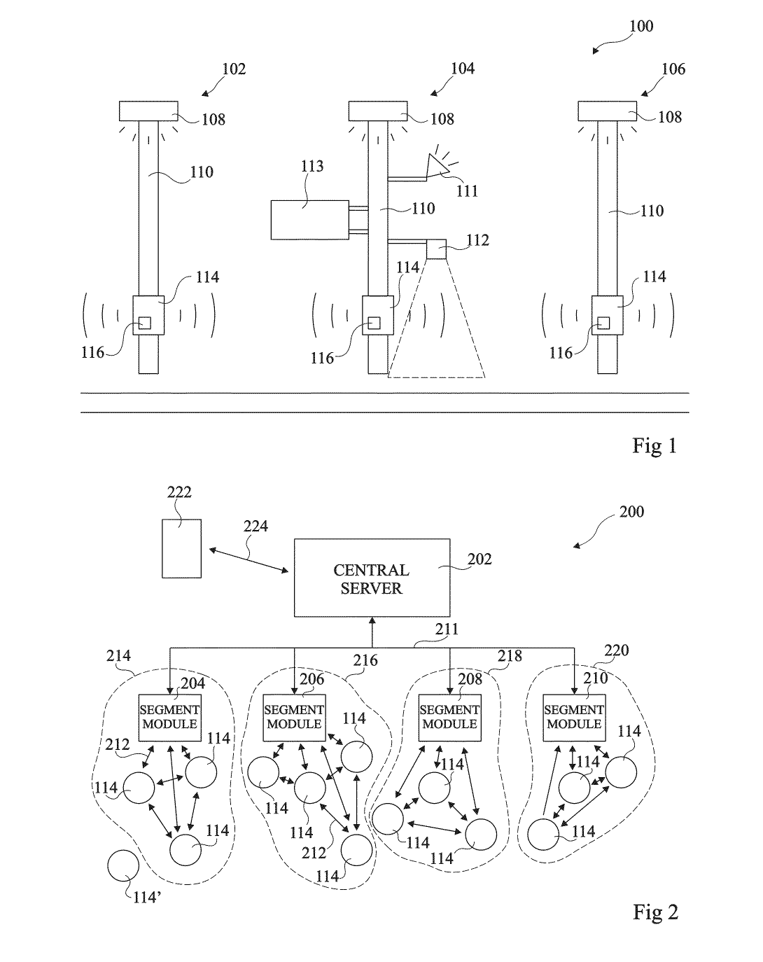

FIG. 1 illustrates part of a street lighting network 100 comprising three lamps 102, 104 and 106. Of course, the whole lighting network may comprise many more than three lamps, for example hundreds or thousands of lamps.

Each lamp 102, 104, 106 comprises one or more light elements 108, for example comprising one or more LEDs, and for example orientated to light a certain area, such as a street below. The light elements 108 are for example each suspended from a corresponding lamp post 110.

In addition to the light element 108, each lamp 102, 104, 106 may additionally comprise other lighting elements or devices. For example, as shown in FIG. 1, the lamp 104 for example includes a LED spotlight 111, a motion or presence detector 112, and an LED panel 113. The motion or presence detector 112 for example detects a pedestrian or vehicle passing in the proximity of the lamp, and controls in response one or more of the light elements 108, for example causing a light element to turn on or increase its brightness. The LED panel 113 for example allows information to be displayed, such as traffic information or advertising material.

Each of the lamps 102, 104 and 106 additionally comprises a wireless lamp controller 114, represented by boxes in FIG. 1, which is for example in wireless communication with one or more other surrounding wireless lamp controllers, and controls the one or more light elements of the corresponding lamp. For example, each lamp is coupled to a power supply line (not shown in FIG. 1) via the wireless lamp controller 114, such that the wireless lamp controllers 114 can control which of the light elements is powered. In order to vary the brightness of LED light elements, the current supplied to each LED element is for example controlled by an LED driver or an electrical ballast of the wireless lamp controller.

As will be described in more detail below, each wireless lamp controller 114 for example comprises a machine readable element 116, such as a QR (quick response) code or the like, for use during installation. For example, the machine readable element 116 is physically attached to a housing of wireless lamp controller 114.

FIG. 2 illustrates an overview of the lighting control system according to an example embodiment.

A central server 202 is for example in communication with a number of segment modules 204, 206, 208 and 210. The central server 202 is for example coupled to the segment modules 204 to 210 via a wired network 211, although in alternative embodiments the connection could be at least partially wireless. While FIG. 2 illustrates an example in which there are four segment modules, in alternative embodiments the lighting control system 200 could comprise less than four such modules, for example at least two, or many more than four modules, for example tens or hundreds.

Each of the segment modules 204 to 210 is for example in communication with a number of the wireless lamp controllers 114 that are within its surrounding area, defining corresponding segments 214, 216, 218 and 220 in FIG. 2 associated with the segment modules 204, 206, 208 and 210 respectively.

Each wireless lamp controller 114 is assumed to be installed in a corresponding lamp (not illustrated in FIG. 2). The wireless lamp controllers 114 are represented by circles in FIG. 2. Each wireless lamp controller 114 is for example associated with a single segment module 204, and the number of controllers 114 associated with each of the segment modules 204 to 210 could be anything from one to several thousand.

The wireless lamp controllers 114 are each for example in direct wireless communication range of their corresponding segment module 204. However, in alternative embodiments, communication between any of the segment modules and one or more of the wireless lamp controllers 114 of its segment could be via one or more other wireless lamp controllers 114, which may relay the communications. Each wireless lamp controller 114 is also for example able to wirelessly communicate with one or more other wireless lamp controllers 114 of the same segment.

The wireless lamp controllers 114 illustrated in FIG. 2 are assumed to be integrated within the system, in other words they have been installed and activated.

FIG. 2 also illustrates a new wireless lamp controller 114′ that is to be added to the system 200. Therefore, it is for example not yet capable of wireless communication with any of the other wireless lamp controllers 114, and it has not yet been assigned to any segment module or segment. An installation device 222 is used during the installation of such new controllers. The installation device 222 is for example in communication with the central server 202 via a connection 224, which could comprise wired and/or wireless connection paths, such as communication via a mobile communications network and/or the internet. For example, the communication could be via a WPAN (wireless packet area network) and/or via a UMTS (universal mobile telecommunications system) network.

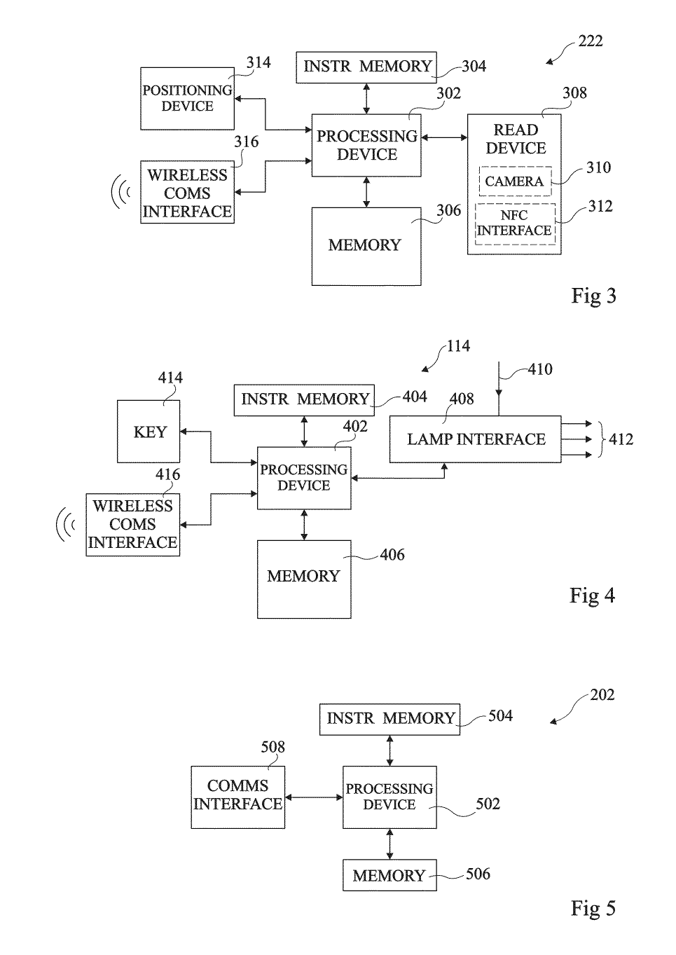

FIG. 3 illustrates the installation device 222 of the system 200 of FIG. 2 in more detail according to an example embodiment.

As illustrated in FIG. 3, the device 222 for example comprises a processing device 302, which for example comprises one or more processors. The processing device 302 is for example configured to execute software instructions stored in an instruction memory 304, although in alternative embodiments, the functions of the installation device 222 could at least partially be implemented as a hardware solution in the processing device 302 independently of software. The processing device 302 is also for example coupled to a memory 306, storing for example setup parameters read from a new wireless lamp controller 114 to be added to the lighting control system, as will be described in more detail below.

The installation device 222 also for example comprises a read device 308, capable of reading the machine readable element 116 of a new wireless lamp controller 114′.

For example, in one embodiment, the read device 308 comprises a digital camera 310, for example comprising an image sensor capable of capturing an image of the machine readable element 116. In such a case, the machine readable element 116 is for example a visual element, such as a bar code or QR (quick response) code.

Additionally or alternatively, the read device 204 may comprise an NFC (near field communications) interface 312, capable of wireless communication with the machine readable element 116. In such a case, the machine readable element 116 is for example an RF transponder, or the like.

The installation device 222 also for example comprises a positioning device 314, indicating a current geographical location of the installation device 222. For example, as is known in the art, the positioning device 314 could comprise a global positioning system (GPS) device and/or communications network based positioning device.

The installation device 222 also for example comprises a wireless communications interface 316, permitting wireless communications with the central server 202 via the connection 224 of FIG. 2.

In one embodiment, the installation device 222 could be a smartphone, in which an application suitable for implementing the functions of the installation device has been installed.

FIG. 4 illustrates a wireless lamp controller 114 in more detail according to an example embodiment. The new wireless lamp controller 114′ of FIG. 2 for example comprises the same elements.

As illustrated, the wireless lamp controller 114 for example comprises a processing device 402, which for example comprises one or more processors. The processing device 402 is for example configured to execute software instructions stored in an instruction memory 404, although in alternative embodiments, the functions of the wireless lamp controller could at least partially be implemented as a hardware solution in the processing device 402 independently of software. The processing device 402 is also for example coupled to a memory 406, which for example stores control parameters indicating a lighting sequence to be applied for a given time period by the wireless lamp controller, such as a 24 hour period.

The processing device 402 is also for example coupled to a lamp interface 408, which for example receives one or more input power supply lines 410, and provides supply voltages on one or more output power supply lines 412 to one or more light elements. Of course, while the lamp interface 408 is for example implemented within the housing of the wireless lamp controller 114, in some embodiments the lamp interface 408 may at least partially be implemented with one or more of the light elements 108.

The lamp interface 408 for example permits the activation and deactivation of one or more of the light elements 108, and/or a brightness control of one or more of the light elements 108, for example by controlling the current supplied to these elements. In the case of an LED panel, such as panel 113 in FIG. 1, the lamp interface 408 for example also transmits information to be transmitted to the LED panel for display. In the case of a motion or presence detector, such as detector 112 of FIG. 1, the lamp interface 408 also for example receives a signal from the detector indicating a detected presence, and in response controls one or more of the light elements 108 via lines 412. Furthermore, in some embodiments, the lamp interface 408 also receives maintenance information from the one or more light elements 108, for example indicating whether the light element is functioning correctly.

The wireless lamp controller 114 also for example comprises a memory 414 storing an encrypted key associated with the wireless lamp controller 114. As will be described in more detail below, the encrypted key for example permits a secure activation of the wireless lamp controller 114 during the installation procedure. The memory 414 is for example protected from tampering by one or more protection mechanisms, as are known in the art.

As with the installation device 222, the wireless lamp controller 114 also for example comprises a wireless communication interface 416, permitting wireless communication with other devices, such as other wireless lamp controllers 114 and/or with one of the segment modules 204 to 210 of FIG. 2.

FIG. 5 illustrates the central server 202 of FIG. 2 in more detail according to an example embodiment.

As illustrated, the central server 202 for example comprises a processing device 502, which for example comprises one or more processors. The processing device 502 is for example configured to execute software instructions stored in an instruction memory 504, although in alternative embodiments, the functions of the central server 202 could at least partially be implemented as a hardware solution in the processing device 502 independently of software. The processing device 502 is also for example coupled to a memory 506, which for example stores information regarding the lighting control system 200. For example, the memory 506 stores position data associated with each wireless lamp controller 114 and with each segment module 204 to 210 of FIG. 2. Furthermore, the memory 506 also for example stores reference keys associated with each wireless lamp controller 114 in the lighting control system, which for example correspond to keys stored in the memory 414 of the wireless lamp controllers 114, as will be described in more detail below.

The central server 202 also for example comprises a communications interface 508, for example permitting wired and/or wireless communications with the installation device 222 and with each of the segment modules 204 to 210.

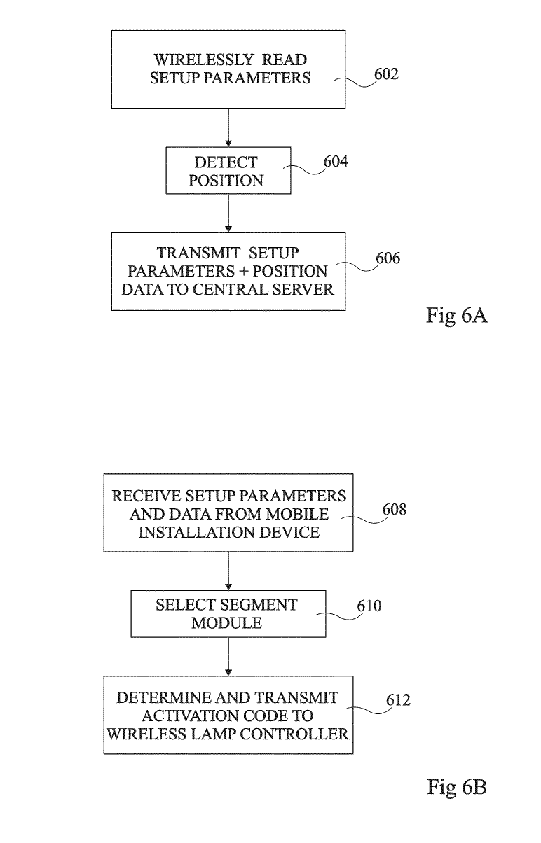

FIG. 6A is a flow diagram showing an example of operations performed by the installation device 222 of FIG. 2 when a new wireless lamp controller, such as the controller labeled 114′ in FIG. 2, is to be added to the lighting control system 200.

In a first operation 602, the installation device 222 reads setup parameters from the machine readable element 116 of the new wireless lamp controller 114′. For example, the installation device 222 uses the read device 308 illustrated in FIG. 3.

The setup parameters for example include a unique identifier, such as a serial number of the wireless lamp controller 114′. The setup parameters may additionally or alternatively include other information, such as the functions of the wireless lamp controller 114′, indicating for example the number of light elements 108 that may be controlled, the brightness options that may be selected, the available inputs, such as sensors or measurement functions, etc. Furthermore, the setup parameters may additionally or alternatively include an encrypted key associated with the wireless lamp controller 114′.

In a subsequent operation 604, the installation device 222 detects its current position, for example using the positioning device 310 illustrated in FIG. 3. For example, the position is provided as a longitude value and a latitude value, although other formats of the position data would be possible.

In a subsequent operation 606, the setup parameters and the position data are transmitted to the central server 202, via the connection 224 shown in FIG. 2.

FIG. 6B is a flow diagram showing an example of the operations performed by the central server 202 during the installation of a new wireless lamp controller, such as the controller labeled 114′ in FIG. 2.

As illustrated, in an operation 608, the central server 202 for example receives the setup parameters and the position data from the installation device 222. The central server 202 for example verifies the validity of the encrypted key, for example by comparing it to a key stored in its memory in association with the identifier of the wireless lamp controller 114′. In particular, the memory 506 of the central server for example stores a list of identifiers of all wireless lamp controllers already installed in the system and to be installed within the system, and also a copy of the key associated with each wireless lamp controller.

In a subsequent operation 610, the central server 202 for example assigns a segment module, such as the segment module 204 of FIG. 2, to the wireless lamp controller 114′, based on the position data received from the installation device 222. In particular, the central server 202 for example selects a segment module that is physically closest to the geographical location of the installation device 222. Indeed, it is assumed that the installation device 222 is in close proximity with the wireless lamp controller 114′ during installation, and thus the position of the installation device 222 is considered to also be the position of the wireless lamp controller 114′. To select the closest segment module, position data associated with each segment module is for example compared with the position data of the installation device 222 to determine the distances separating the installation device from each segment module, and the segment module having the smallest distance is for example selected.

In some embodiments, additional information may be taken into account when selecting the appropriate segment module, such as the presence of any obstructions, such as buildings or mounds, which may interfere with wireless communications between the wireless lamp controller 114′ and one or more of the segment modules.

In a subsequent operation 612, an activation code is generated by the central server 202, and transmitted to the wireless lamp controller 114′ via the segment module selected in operation 610. In particular, based on the unique identifier and/or on the encrypted key received from the wireless lamp controller, an appropriate activation code is generated, and transmitted to the selected segment module, which in turn wirelessly transmits the activation code to the wireless lamp controller 114′.

For example, in one embodiment, the activation code comprises the encrypted key of the wireless lamp controller 114′, and is transmitted along with the unique identifier of the wireless lamp controller 114′. For example, this permits the wireless lamp controller 114′ to verify that the activation code is authentic. Furthermore, the activation code may comprise other data, such as the position data of the wireless lamp controller and/or data stored with the QR code associated with the wireless lamp controller 114′. The activation code may also include data permitting the wireless lamp controller 114′ to communicate within the network, for example with its assigned segment module and with one or more of the other wireless lamp controllers in its segment.

In one embodiment, the central server 202 is configured to store the position data in a memory in association with the identifier of the wireless lamp controller 114′, and to transmit the position data to the wireless lamp controller 114′, for example as part of the activation code. In future communications with the wireless lamp controller 114′, the position data for example provides a further means of authenticating the controller.

In response to receiving the activation code from the central server 202, the new wireless lamp controller 114′ is for example activated, and establishes wireless connections with neighbouring wireless lamp controllers 114 already installed in the system, and for example stores data indicating its assigned segment module, such as a unique identifier of the segment module. The new wireless lamp controller 114′ is then for example capable of receiving data from the central server 202 and/or other wireless lamp controllers, for example for modifying or over-riding its programmed lighting sequence, and also of transmitting data, for example indicating to surrounding wireless lamp controllers when the presence of a pedestrian or vehicle has been detected by its presence detector 112.

An advantage of the embodiments described herein is that a new wireless lamp controller may be installed in a lighting control system in a fast and efficient manner, by selecting an appropriate segment module based on position data associated with an installation device. Furthermore, the use of an encrypted key permits the installation of a new wireless lamp controller to be effected in a secure manner.

Having thus described at least one illustrative embodiment, various alterations, modifications and improvements will readily occur to those skilled in the art.

For example, while a single installation device has been described, it will be apparent to those skilled in the art that there could be multiple installation devices operating in the lighting control system, which can be used in parallel with each other to install new wireless controllers.

1. A method of installation of a wireless lamp controller in a lighting control system, the method comprising:
reading, by a mobile installation device, setup parameters from a machine readable element of said wireless lamp controller;
determining position data indicating a current position of the mobile installation device; and
transmitting, by the mobile installation device, the setup parameters and the position data to a central server.

2. The method of claim 1, further comprising receiving, by the wireless lamp controller, an activation code provided by the central server.

3. The method of claim 1, wherein said setup parameters comprise one or more of:
an encrypted key associated with said wireless lamp controller;
an identifier associated with said wireless lamp controller; and
data indicating functions of said wireless lamp controller.

4. The method of claim 1, wherein said machine readable element is one of:
an image readable by a camera of said mobile installation device; and
a wireless transponder readable by a near-field communications interface of said mobile installation device.

5. The method of claim 1, further comprising:
receiving by said central server the setup parameters and position data from the mobile installation device;
generating an activation code based at least partially on one or more of said setup parameters;
based on said position data, selecting one of a plurality of segment modules of said lighting control system; and
transmitting said activation code to said wireless lamp controller via said selected segment module.

6. The method of claim 5, wherein the setup parameters comprise an encrypted key associated with said wireless lamp controller, and wherein said central server is adapted to compare said key with a reference key associated with said wireless lamp controller.

7. The method of claim 5, further comprising:
storing by said central server said position data in a memory in association with an identifier of said wireless lamp controller; and
transmitting by said central server said position data to said wireless lamp controller.

8. A mobile installation device comprising:
a read device configured to read setup parameters from a machine readable element of a wireless lamp controller to be installed in a lighting control system;
a positioning device configured to determine position data indicating a current position of the mobile installation device; and
a wireless communications interface configured to transmit the setup parameters and the position data to a central server.

9. The mobile installation device of claim 8, wherein said read device is one of:
a camera configured to capture an image of said machine readable element; and
a near-field communications interface configured to wirelessly communicate with said machine readable element.

10. A lighting control system comprising a central server adapted to:
receive, from a mobile installation device, setup parameters associated with a wireless lamp controller to be installed in said system, and position data associated with said mobile installation device;
generate an activation code based at least partially on one or more of said setup parameters;
select, based on said position data, one of a plurality of segment modules of said lighting control system; and
transmit said activation code to said wireless lamp controller via said selected segment module.

11. The system of claim 10, wherein the setup parameters comprise an encrypted key associated with said wireless lamp controller, and wherein said activation code includes said key.
